(19) United States
(12) Patent Application Publication
(10) Pub. No.: US 2005/0110455 A1
(43) Pub. Date: May 26, 2005

(54) Integrated charger for use in a car

(76) Inventor: Fu-I Yang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/718,673

(22) Filed: Nov. 24, 2003

(51) Int. Cl. H02J 7/00

(52) U.S. Cl. 320/107

(57) ABSTRACT

The invention relates to an integrated charger for use in a car having a charging seat and a power supply head. The charging seat includes a charging groove for receiving and charging dry batteries. A power supply head adapted to a cigarette lighter socket in the car is inserted thereinto for leading the power source into the charging seat. The power supply head and the charging seat are integrated in a body for a direct and convenient charging of the dry batteries.

### BACKGROUND OF THE INVENTION

1. Field of the Invention

The invention relates to an integrated charger for use in a car, and more particularly, to a device having a charging seat and a power supply head insertable into a cigarette lighter socket in the car. Both of which are integrated in a body for a direct and convenient charging process for dry batteries.

2. Description of the Related Art

With the development of technologies, electronic apparatuses, like cellular phones, digital cameras, Game Boy, PDA, etc., become very popular in this generation. All of these electronic products need dry batteries as power source.

These apparatuses are useful, particularly for an outing. When one makes an outing for a longer period, the battery power for cellular phones is easily exhausted and this will cause much inconvenience. For example, when one makes an outing in the car, the power for his cellular phone is used up. Therefore, a charger for use in a car was developed for preventing inconvenience caused by this situation.

Referring to FIGS. 1 and 2, a conventional cellular phone charged in a car is shown. This prior art includes a connector 12 insertable into a cigarette lighter socket 11 in the car, a charging unit 13 and a power cord 14. When the connector 12 is inserted into the cigarette lighter socket and the free end of the power cord 14 is attached to the cellular phone 15, a charging process can begin. Referring to FIGS. 3 and 4, another prior art cellular phone charged in a car is shown. The connector 12 is connected to the charging seat 16 through a power cord 14. Thereafter, the cellular phone 15 is placed on the charging seat 16 for performance of the charging process.

In the above-mentioned charging ways, a power cord 14 must extend from the connector 12 for charging the cellular phone. The power cord 14 and the charging seat 16 occupy space in the car, even disturb the driver while driving. Thus, it's not a practical design.

Moreover, most charging seats 16 for use in the car can be used only for charging cellular phones rather than for charging common dry batteries, such as AA, AAA, Li-ion, etc. batteries. Electronic products, like digital cameras, PDA or Game Boy, all need the aforementioned dry batteries. It would be much inconvenient when one can't charge these batteries in going for an outing.

Consequently, the prior art leaves much to be improved.

### SUMMARY OF THE INVENTION

It is a primary object of the invention to provide an integrated charger with which the common dry batteries can be conveniently charged directly in the car so that the user always has fully charged dry batteries when going for an outing.

It is another object of the invention to provide an integrated charger whose charging seat and power supply head are integrated in a body, thereby reducing the occupied space and ensuring a using comfort without disturbing the driver while driving.

It is a further object of the invention to provide an integrated charger in which the charging control circuit and the DC-DC converter are fitted within the charging seat that is then combined with the power supply head to be a compact, lightweight and convenient charger with appealing appearance.

### BRIEF DESCRIPTION OF THE DRAWINGS

The accomplishment of this and other objects of the invention will become apparent from the following descriptions and its accompanying drawings of which:

FIG. 1 is a schematic drawing of a first conventional charger for use in a car;

FIG. 2 is a schematic drawing of a cellular phone charged in a car by the charger in accordance with FIG. 1;

FIG. 3 is a schematic drawing of a second conventional charger for use in a car;

FIG. 4 is a schematic drawing of a cellular phone charged in a car by the charger in accordance with FIG. 3;

FIG. 5 is a perspective view of a first embodiment of the invention;

FIG. 6 is a sectional view of the first embodiment of the invention;

FIG. 7 is a circuit block diagram of the invention;

FIG. 8 is a sectional view of a second embodiment of the invention;

FIG. 9 is a sectional view of the second embodiment of the invention, showing the swiveled power supply head in different positions;

FIG. 10 is a schematic drawing of the first embodiment of the invention charged in a car; and

FIG. 11 is a schematic drawing of the second embodiment of the invention charged in a car.

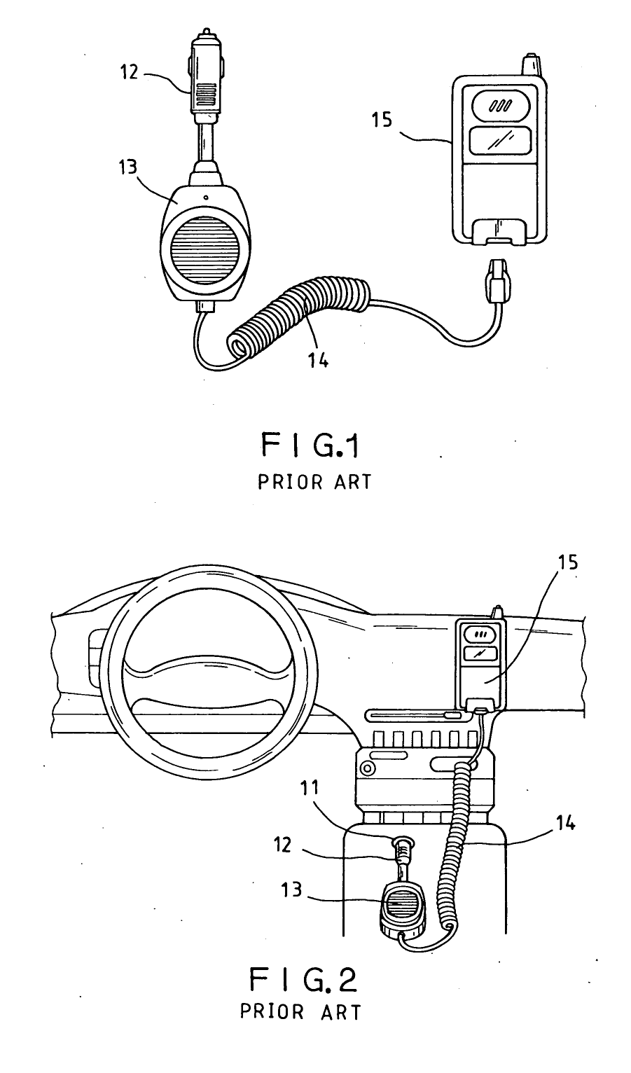

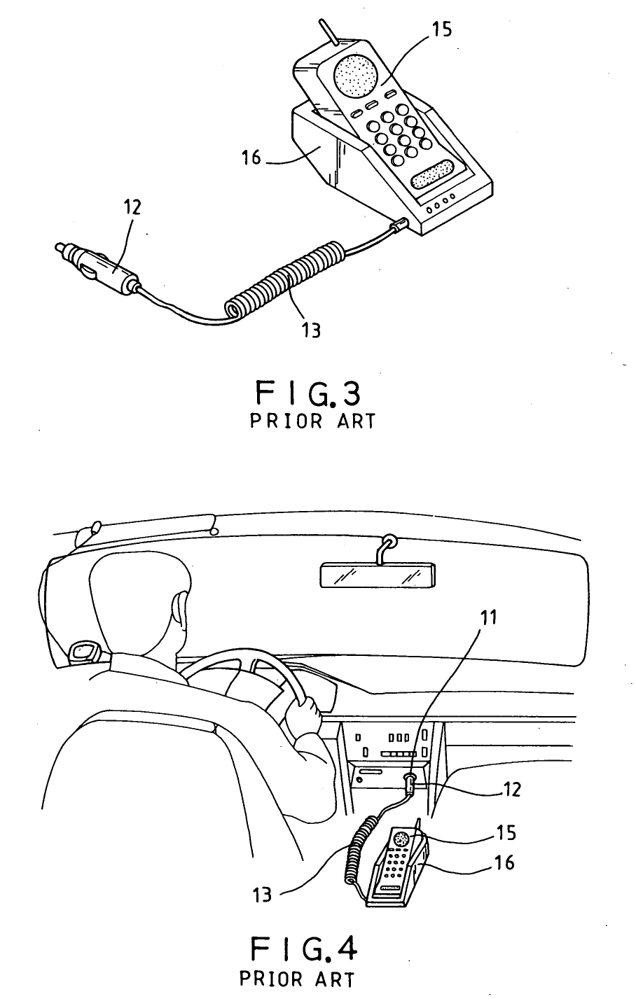

### DETAILED DESCRIPTION OF THE PREFERRED EMBODIMENT

First of all, referring to FIGS. 5, 6 and 7, the charger in accordance with the invention includes a charging seat 2 having a charging groove 21 for charging and receiving dry batteries B in specification of currently most popular AA, AAA or Li-ion. Of course, it can be designed for charging Ni—MH, Ni—Cd batteries. As shown in FIG. 5, the charging groove is designed for receiving two AA-type dry batteries. This design doesn't occupy much space. Also, it's convenient to hold it with hand. With the specification for AA-type dry batteries, this design is also suitable for AAA-type dry batteries by use of pivotably connected charging terminal plates 211. This charging terminal plate 211 is not the object of the invention so that no further descriptions are given hereinafter. The invention is featured by the design of the charging groove 21 that corresponds to the shape of dry batteries to be charged, for example, Li-ion dry batteries used by cellular phones. The Li-ion dry battery has a dimension similar to the size of two AA-type dry batteries. Therefore, it's not difficult to achieve this goal.

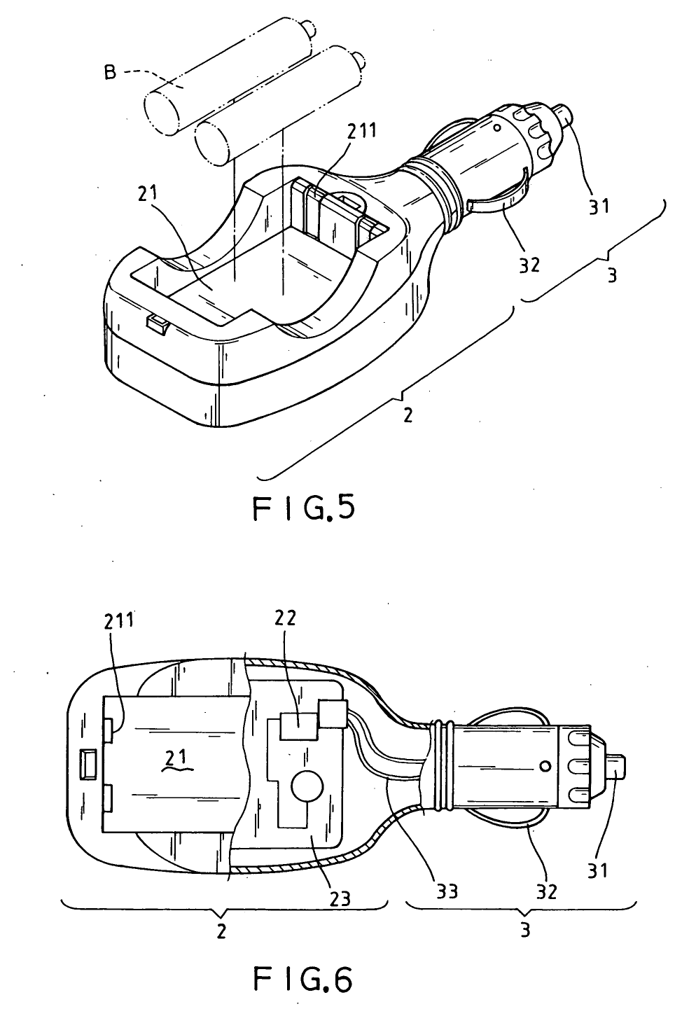

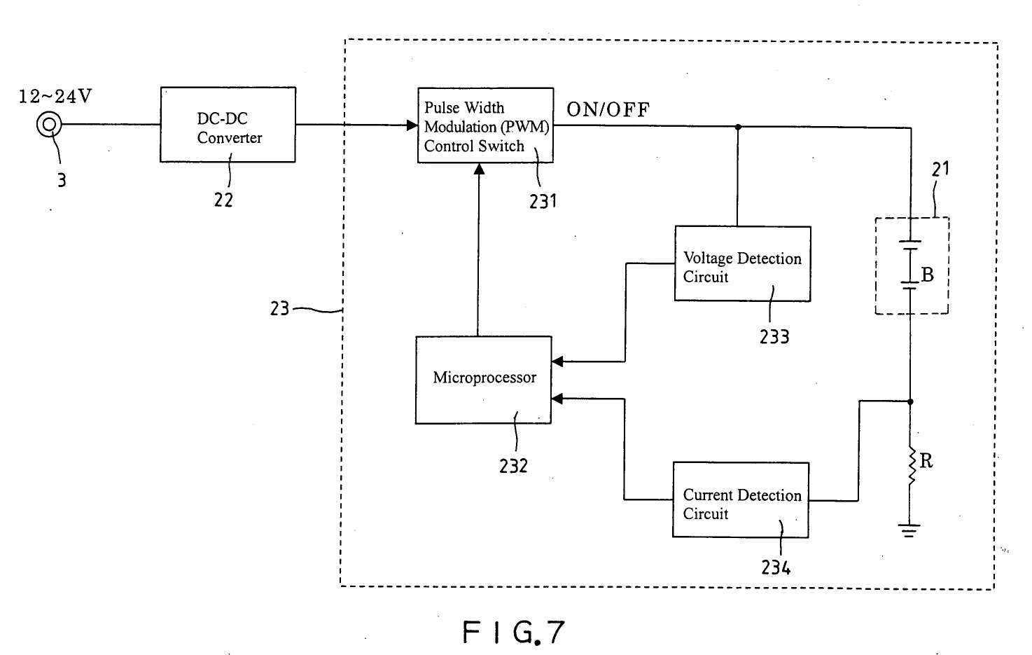

In addition, as shown in FIG. 6, the charging seat 2 includes a DC-DC converter 22 under the charging groove 21. As the cigarette lighter in car supplies the voltage of 12˜24 V that doesn't correspond to the charging voltage for the common dry batteries, the DC-DC converter 22 is employed to adjust it to a desired DC voltage for a charging control circuit 23 disposed on a circuit board. Moreover, this is so arranged that the charging terminal plates 211 protrude at both sides of the charging groove 21.

Furthermore, a power supply head 3 corresponding to a car cigarette lighter socket is cylindrically formed at the front part of the charging seat. It has a telescopic positive terminal 31 projecting outwardly from the center of the distal end of the power supply head 3 and two negative terminals 32 of contact reed projecting from both sides of the circumference thereof in an arched form. The embedded power cords 33 extended from the positive terminal 31 and the negative terminal 32, and lead to the DC-DC converter 22 for creating an electrical connection. The power supply head 3 and the charging seat 2 are integrated in a body.

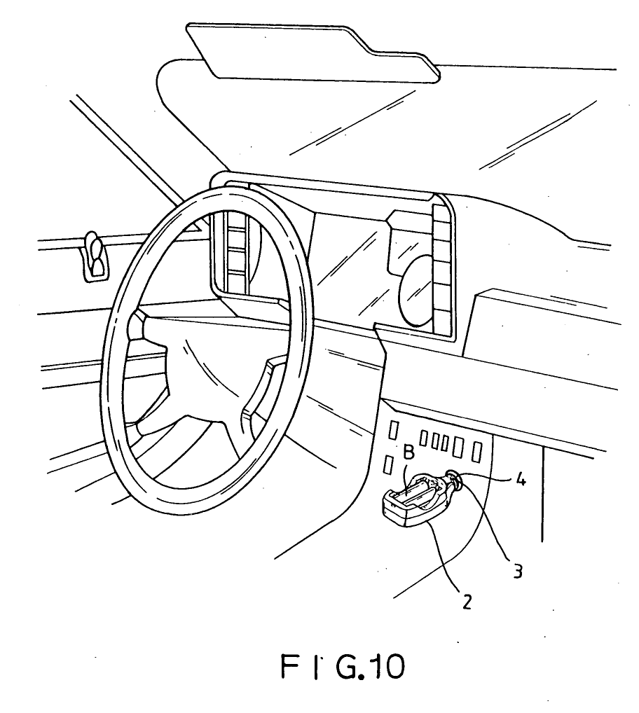

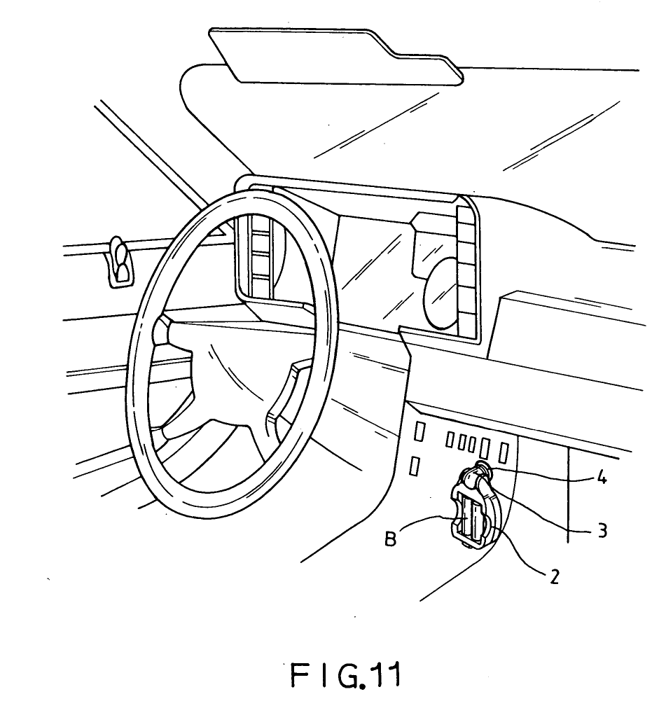

Now, referring to FIG. 7, a circuit diagram of the invention is shown. When the power supply head 3 is inserted into the cigarette lighter socket 4 (see FIG. 10), the voltage of 12˜24 V is transmitted to the DC-DC converter 22 within the charging seat 2 that reduces the input DC voltage to a desired voltage for the charging control circuit 23. The charging control circuit 23 includes a pulse width modulation (PWM) control switch 231, a microprocessor 232, a voltage detection circuit 233 and a current detection circuit 234. After performance of the voltage and current detection of the batteries B received within the charging groove 21, the microprocessor 232 controls the pulse width modulation control switch 231 for switching the power supplied from the DC-DC converter 22 to the charging groove 21 in the ON or OFF state. In this way, the power supplied through the power supply head 3 can smoothly lead into the charging groove 21 for performance of the charging process. When the dry batteries B are charged in a full state, the charging control circuit 23 controls the pulse width modulation control switch 231 to bring an end to the power supply, thereby ensuring a normal operation of the dry batteries B for a longer period.

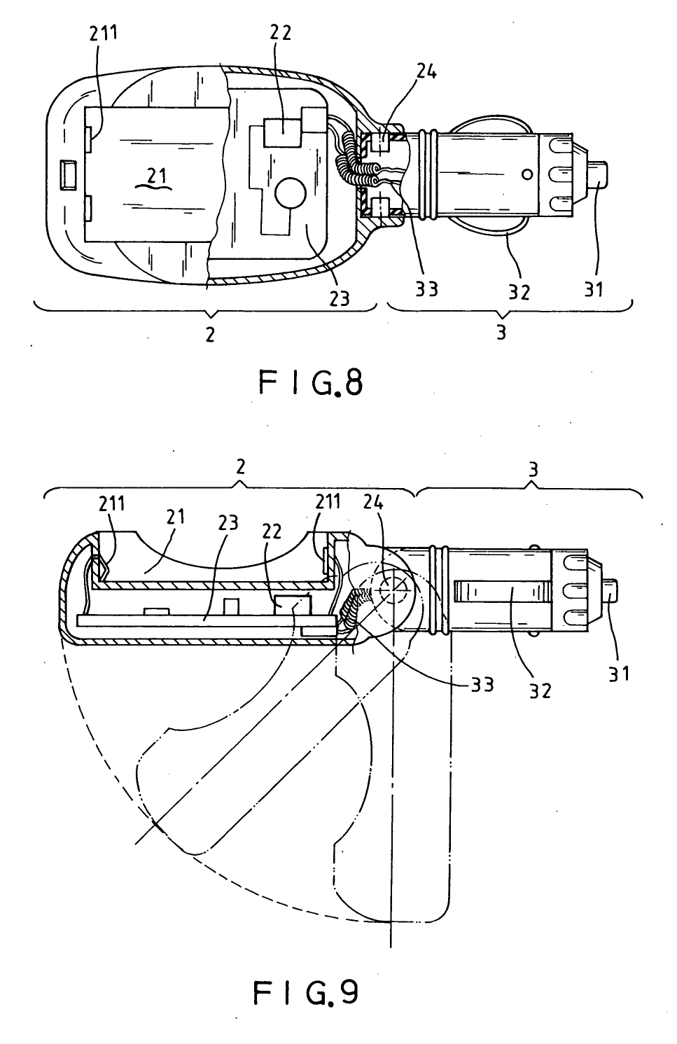

Referring to FIGS. 8 and 9, another embodiment of the invention is shown. The power supply head 3 is rotatably connected to the front member of the charging seat 2 by means of a pivot 24 so that the power supply head 3 can be swiveled in a certain angle. Meanwhile, the power cords 33 must be flexible for the swiveling action of the power supply head 3. Alternatively, the pivot 24 can be provided with conductive pieces for transmitting power. This belongs to the prior art so that no further descriptions are given hereinafter.

Then, referring to FIGS. 10 and 11, the invention installed in a car is shown. As shown in FIG. 10, the power supply head 3 and the charging seat 2 are integrated in a body that is conveniently inserted into the cigarette lighter socket 4 for charging the dry batteries B. Furthermore, as shown in FIG. 11, the charging seat 2 is swiveled in a sloping position for preventing it from occupying much space. Unlike the prior art having the exposed charging unit 13 and the extension cord 14, these two embodiments utilize the integrated configuration of the power supply head 3 and the charging seat 2 into one body, thereby making the whole boy compact, lightweight, easy in use. Moreover, the charger in accordance with the invention can be used for charging the common dry batteries in AA, AAA, etc. types. Thus, this enables a comfortable outing in the car without worry about lack of power for cellular phones or other units.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1. An integrated charger for use in a car comprising:
a) a charging seat having a charging groove for receiving and charging dry batteries, a DC-DC converter and a charging control circuit; and
b) a power supply head formed in a cylindrical shape and adapted to a cigarette lighter socket in the car for insertion thereinto to lead the power source into the charging seat, the power supply head and the charging seat being integrated in a body in such a manner that the power cords embedded within the power supply head create an electrical connection with the DC-DC converter.

2. The integrated charger for use in a car as recited in claim 1 wherein the power supply head and the charging seat are attached to each other in a body.

3. The integrated charger for use in a car as recited in claim 1 wherein the power supply head is pivotally connected to the charging seat so that the power supply head is swiveled on a pivot in a sloping position.

4. The integrated charger for use in a car as recited in claim 1 wherein the power supply head includes a positive terminal telescopically extended from the center of the distal end of the power supply head and two negative terminals projecting from both sides of the circumference thereof in an arched form.

5. The integrated charger for use in a car as recited in claim 1 wherein the charging groove is so configured that any types of dry batteries, such as AAA, AA, Li-ion, Ni—NM, Ni—Cd, etc., can be fitted into the charging groove.

6. The integrated charger for use in a car as recited in claim 1 wherein the charging control circuit includes a pulse width modulation (PWM) control switch, a microprocessor, a voltage detection circuit and a current detection circuit, and wherein, after the voltage and current detection of the batteries received within the charging groove, the microprocessor controls the pulse width modulation control switch for switching the power supplied from the DC-DC converter to the charging groove in the ON or OFF state.
